(19) United States
(12) Patent Application Publication
(10) Pub. No.: US 2005/0097012 A1
(43) Pub. Date: May 5, 2005

(54) Production planning method and apparatus

(76) Inventor: Tomohiko Maeda, Kawasaki (JP)

Correspondence Address: STAAS & HALSEY LLP, SUITE 700, 1201 NEW YORK AVENUE, N.W., WASHINGTON, DC, 20005, US

(21) Appl. No.: 10/977,939

(22) Filed: Nov. 1, 2004

(30) Foreign Application Priority Data
Oct. 31, 2003 (JP) 2003-372556

(51) Int. Cl. G06F 17/60

(52) U.S. Cl. 705/28

(57) ABSTRACT

A production planning apparatus in a production line which conducts production in each process includes an on-line push/pull type production planning device, an off-line system control device and memory connected to the push/pull type production planning device and the system control device, for storing a variety of information. The push/pull type production planning device determines the behavior of a target process based on the amount of requirements from a post-process, the predetermined amount of products in progress and the achieved amount of products in progress; and the system control device optimizes parameters.

### BACKGROUND OF THE INVENTION

1. Field of the Invention

The present invention relates to a production planning method in a production line and an apparatus for implementing the method.

More particularly, the present invention relates to a production planning method suitable for variable-type and variable amount production for realizing turnaround time (TAT) (time until shipping a product after putting materials in a production line) reduction, shelf stock (total amount) suppression and work efficiency by adapting to production fluctuations and a product life cycle and realizing an optimal production flow, and an apparatus for implementing it in the production line of a manufacturing plant, where it is difficult to suppress the amount of stock since bottleneck changes from time to time due to an irregular facility failure, the production of a variety of products and a complex process route per product type. In this case, bottleneck means the increase of the stock of half-finished products due to the insufficient capacity of a specific production process, of a plurality of production processes.

2. Description of the Related Art

As a prior production method, there is a technology for developing a stockpile plan for each parts number of a well-sold product in a stock supplementation type production method and preventing the total shortage of products including products other than the well-sold product (for example, see Patent Reference 1). There is also a technology for reducing the stock of a production line by rationalizing un-streamlined production site in which it is difficult to implement a just-in-time production method immediately, in connection with a stock reduction method in a production line and a synchronous production method for implementing it (for example, see Patent Reference 2).

In the prior production method, with the improvement of a recent information technology (IT), the utilization of scheduler (software implemented in a production monitor computer) has been highly demanded. However, conventional scheduler is based on the production plan in a plant, and semi-finished products are inputted regardless of requirements from a post-process, which changes from time to time. Therefore, depending on the production state of the post-process, a large amount of stock occurs, which is a problem.

In order to solve this problem, the plan is re-scheduled and modified based on the current amount of products in progress by collecting achievement information in each process and feeding back the information to the scheduler. However, regardless of neglecting requirements from a post-process, modifications from the initial plan are somewhat absorbed, and as a result, stock can be simply reduced somewhat. Therefore, the violent fluctuations of facilities and order cannot be coped with.

In the just-in-time production method represented by Toyota production method, since a process is performed according to instructions written on a signboard from the post-process, products can be smoothly manufactured without waste. However, the successful operation of a just-in-time production method presumes both the even flow of products and the stabilized number of manufacturing processes. Furthermore, it is difficult to calculate the appropriate amount of instructions. In some types of industry, variable-type and variable-amount production with violent fluctuations cannot be avoided. In this case, the predetermined amount of instructions cannot be modified in a timely timing. Therefore, sometimes stock increases greatly, which is another problem. Therefore, this method cannot be utilized in all manufacturing plants.

Furthermore, some recent TOC (theory of constraints) (one of scheduling theories for maximizing profits by maximizing the amount of throughput, minimizing the amount of stock and minimizing business expenses) takes in scheduler and defines a bottleneck process. In this case, in a post-process, products are manufactured forward and a pre-process is planned backward. FIG. 1 explains forward production planning. For example, if there are one through four processes, each process time is determined in order from process 1. The horizontal axis indicates time. However, FIG. 2 explains backward production planning. In this method, firstly, delivery time is determined, the process time of each pre-process is calculated backward, and when semi-finished products should be supplied to process 1 is determined.

However, in this method, it is difficult to define a bottleneck process and to define a time buffer (buffer for time adjustment in each process), and further dynamically changing bottleneck cannot be coped with. Therefore, if production is conducted according to the result of scheduling, the availability factor of fluctuated bottlenecked facilities degrades to lead to both the degradation of a process capacity and a longer turnaround time (TAT). Therefore, in a plant for variable-type and variable amount production and a plant in which bottleneck changes, according to any prior method, products in progress cannot be suppressed, products cannot be manufactured by a short turnaround time (TAT) and shelf stock cannot be reduced.
Patent Reference 1: Japanese Patent Application No. 2000-94276 (pages 3 and 4, and FIG. 1)
Patent Reference 2: Japanese Patent Application No. 2003-15721 (pages 3 and 4, and FIG. 1)

The prior problems have some presumptions. For example, in order to take in a just-in-time production method, production must be based on a specific presumption, for example, even production must be presumed, and this presumption determines the production method of a plant. Basically, a production method is classified into two of a push type by general-purpose scheduler and a pull type by a just-in-time method. In the push method, processes flow from a pre-process to a post-process in order. However, in the pull method, requirements are made to a pre-process according to the process result of a post-process. In the environment around the current Japanese manufacturing, it is difficult to define either of them.

Japan must continue to win cost competition with South Asian countries including Mainland Chine by realizing variable-type and variable-amount production, a short turnaround time (TAT) and a short lifecycle in the recent Japanese manufacturing. Some enterprises capable of realizing even production including even order and even infrastructure in such an environment can maintain production efficiency by the prior art. However, most of enterprises, more particularly high-tech enterprises, must not only establish priority over overseas competitor enterprises, but also promptly respond to multiple customer requirements due to the commercialization of high-tech devices.

Therefore, the conventional flexible manufacturing for maintaining a specific amount of production cannot be maintained, and a variable-type, variable-amount, variable-delivery and variable -lifecycle production method capable of following up both a product which always changes and its manufacturing method, coping with the fluctuating order of a customer while suppressing the amount of products in progress and coping with the unstable operation of facilities due to an advanced manufacturing technology is demanded.

### SUMMARY OF THE INVENTION

It is an object of the present invention to provide an efficient production planning method capable of conducting flexible production and following up even the fluctuations of bottle-neck even in a variable-type and variable-amount production type production line and an apparatus for implementing the method, in order to solve such problems.

One aspect of the present invention is a production planning method. The production planning method comprises calculating an amount of requirements to a pre-process, based on a difference between a sum of an predetermined amount of products in progress set in each process and an amount of requirements from a post-process, and an actual amount of products in progress and notifying the pre-process of the difference as the accumulated amount of requirements of the post-process (step 1), calculating a valid amount of products in progress, based on an actual amount of products in progress and an amount of requirements in each process (step 2), and dynamically switching and performing a pull type production process if the actual amount of products in progress>the amount of requirements, and a push type production process if the actual amount of products in progress<the amount of requirements, based on a relationship between the actual amount of products in progress and the amount of requirements in each process (step 3).

### BRIEF DESCRIPTION OF THE DRAWINGS

FIG. 1 explains the forward production plan;

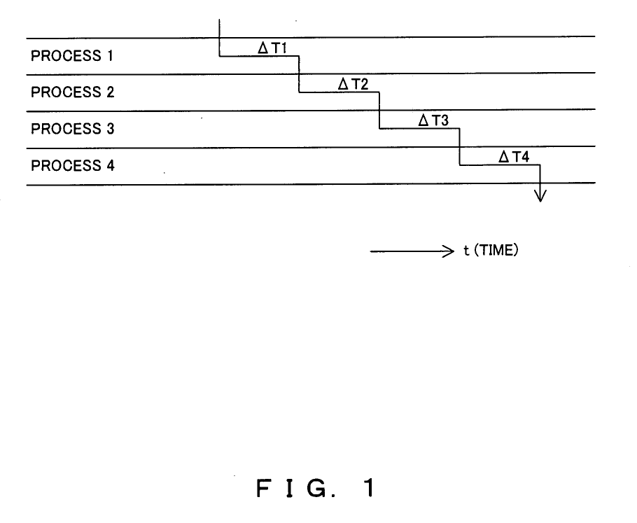

FIG. 2 explains the backward production plan;

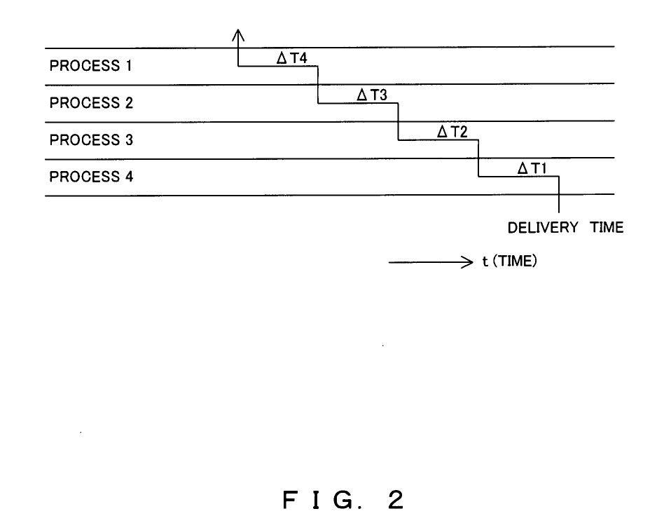

FIG. 3 is a flowchart showing the principle of the method of the present invention;

FIG. 4 is a block diagram showing the principle of the present invention;

FIG. 5 is a flowchart showing the operation of the present invention;

FIG. 6 is a flowchart showing the operation of a system control device;

FIG. 7 is a flowchart showing the operation of a planning unit;

FIG. 8 is a flowchart showing the operation of an order planning unit;

FIG. 9 is a flowchart showing an operation information update operation;

FIG. 10 is a flowchart showing a parameter update operation;

FIG. 11 is a block diagram showing the configuration of one preferred embodiment of the present invention;

FIG. 12 explains parameters in each process;

FIG. 13 explains an example of the first process of the present invention;

FIG. 14 explains an example of the second process of the present invention;

FIG. 15 shows the transition of each amount of products in progress at the time of limiter-off; and

FIG. 16 shows the transition of each amount of products in progress at the time of limiter-on.

### DESCRIPTION OF THE PREFERRED EMBODIMENTS

In the prior art, it must be predetermined which should be used, push or pull, and bottleneck, the amount of instructions and the like must be predetermined. A mechanism for dynamically changing these and controlling them so as to adapt to a manufacturing environment is needed. It is an object of the present invention to automatically provide a push or pull method, based on the change of the amount of products in progress since the amount of products in progress always fluctuates in a plant to organize a production method for matching variable type, variable amount and delivery with lifecycle by dynamically optimizing the amount of instructions in accordance with dynamically changing bottleneck. It is another object of the present invention to provide a job instruction device for switching push and pull for the purpose of efficient production and a system control device for optimizing a variety of parameters in order to control the job instruction device.

The present invention comprises an on-line push/pull type production planning device and an off-line system control device. The production planning device determines the behavior of a target process, based on the amount of requirements from a post-process, the predetermined amount of products in progress and the achieved amount of products in progress. The off-line system control device optimizes parameters. Thus, the production planning device can always maintain appropriate parameters in a planning timing and issues appropriate production instructions.

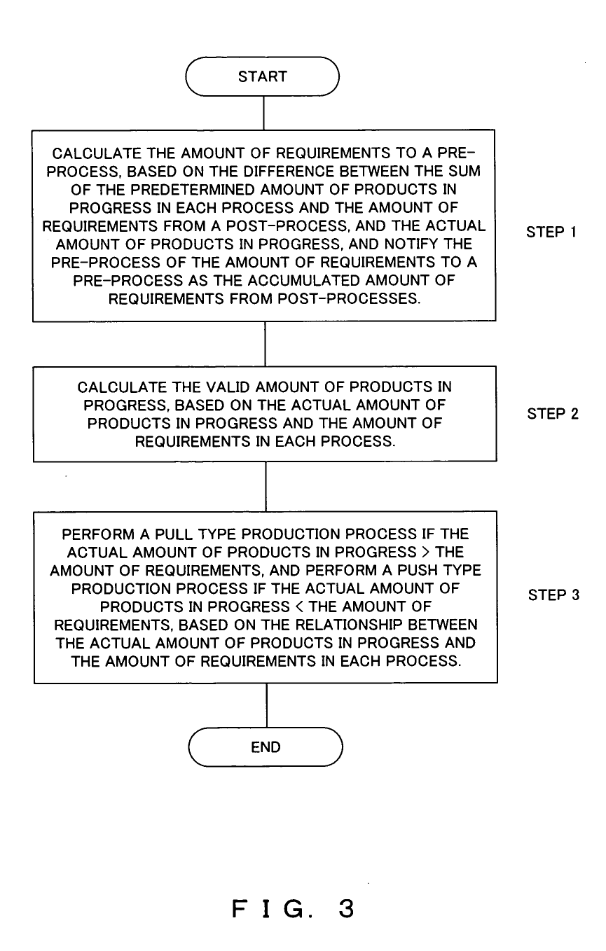

(1) The first aspect of the present invention is as follows. FIG. 3 is a flowchart showing the principle of the method of the present invention. The method comprises calculating the amount of requirements to a pre-process, based on the difference between the sum of the predetermined amount of products in progress set in each process and the amount of requirements from a post-process, and the actual amount of products in progress, and notifying the pre-process of the difference as the accumulated amount of requirements of post-processes (step 1), calculating the valid amount of products in progress, based on the actual amount of products in progress and the amount of requirements in each process (step 2), and dynamically switching and performing a pull type production process if the actual amount of products in progress>the amount of requirements, and a push type production process if the actual amount of products in progress<the amount of requirements, based on the relationship between the actual amount of products in progress and the amount of requirements in each process (step 3).

If the actual amount of products in progress>the amount of requirements, there will be the shortage of semi-finished products. Therefore, a requirement for the shortage is made to a pre-process. If the actual amount of products in progress<the amount of requirements, there is no shortage of semi-finished products. Therefore, a push type production process is performed.

(2) The second aspect of the present invention starts processing a lot with top priority of the entire amount of products in progress of the relevant facility or stops manual work until the valid amount of products in progress exceeds 1, if the valid amount of products in progress for each facility is 0. If the facility is bottlenecked, the process is performed giving priority to an availability factor. If a stable operation is restored and the bottleneck is solved, the amount of products in progress can be suppressed. Furthermore, whether a lot with top priority of the entire amount of products in progress of the facility is started to process or work is stopped until the valid amount of products in progress exceeds 1 is dynamically switched by parameters in memory.

(3) The third aspect of the present invention has the marginal amount of products in progress against the actual amount of products in progress in addition to the predetermined amount of products in progress in each process. If the actual amount of products in progress exceeds the marginal amount of products in progress, a requirement to a pre-process are made 0, requirements to all pre-processes are made 0, a requirement to a pre-process is made 0 and input is temporarily stopped, or requirements to all pre-processes are made 0 and input is temporarily stopped.

(4) The fourth aspect of the present invention performs a push operation in the final process, or has a pull order generation function and utilizes it.

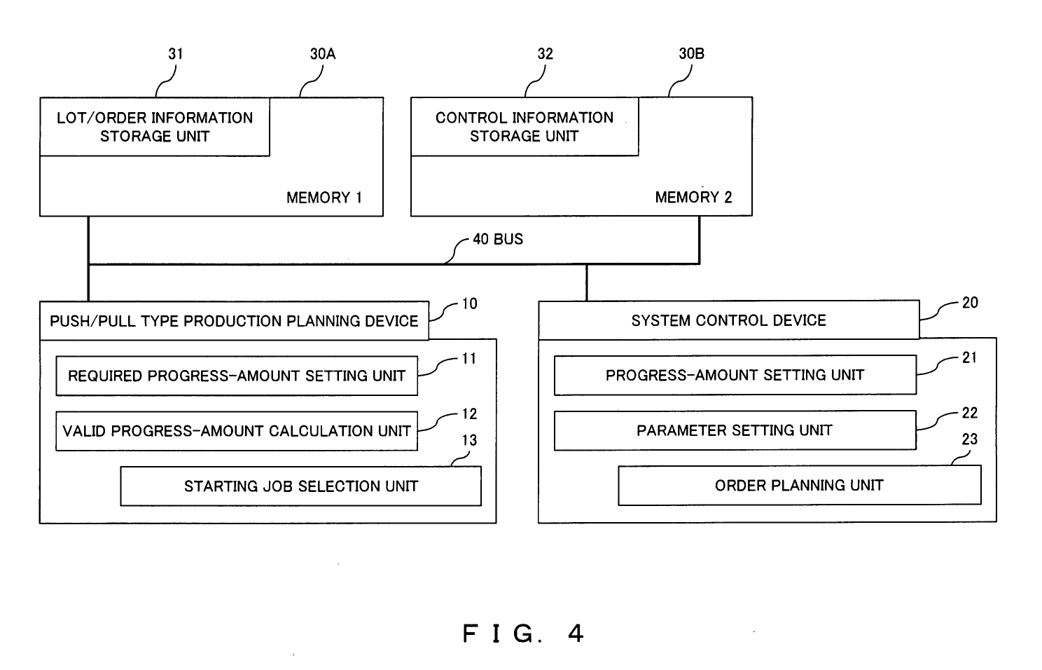

(5) The fifth aspect of the present invention is as follows. FIG. 4 is a block diagram showing the principle of the present invention. In FIG. 4, reference numerals 10, 20 and 30 represent a push/pull type production planning device for making a push/pull type production plan on line, a system control device for controlling a system off line and memory for storing a variety of information necessary for production management, respectively. The memory 30 is composed of memory 30A (memory 1) and memory 30B (memory 2). In the push/pull type production planning device 10, reference numerals 11, 12 and 13 represent a requirement-amount setting unit for setting the required amount of products in progress, a valid progress-amount calculation unit for calculating the valid amount of products in progress and a starting-job extraction unit for extracting a starting job, respectively.

In the system control device 20, reference numerals 21, 22 and 23 represent a progress-amount setting unit for setting the amount of products in progress, a parameter setting unit for setting parameters needed to calculate the amount of products in progress and an order planning unit for planning order, respectively. In the memory 1, a reference numeral 31 represents a lot/order information storage unit for storing lot/order information. In the memory 2, a reference numeral 32 represent a control information storage unit for storing control information. A reference numeral 40 represents a bus for connecting the push/pull type production planning device 10, the system control device 20 and memory 1 and 2 with each other.

(6) In the present invention, the predetermined amount of products in progress is also set in real time by analyzing the state of products in progress in each process and a production plan.

(7) In the present invention, control parameters in memory are also automatically modified dynamically analyzing the state of products in progress in each process and its change rate.

(8) The present invention has predetermined progress-amount information, limiter information, actual progress-amount information and starting principle information in each process as scheduler. The system control device comprises a predetermined progress-amount information setting unit and a control parameter setting unit. The push/pull type production planning device comprises a required progress-amount calculation unit, a valid progress-amount calculation unit and a starting job selection unit.

(1) According to the first aspect of the present invention, an efficient production planning method by which a production process in which bottleneck fluctuates can follow up even bottleneck and flexibly manufacture products can be provided by optimally controlling the amount of products in progress in each production process.

(2) According to the second aspect of the present invention, an efficient production planning method can be provided.

(3) According to the third aspect of the present invention, the flow of the entire production can be made smooth by setting a limit in the amount of products in progress, and making a requirement to a pre-process to 0, making a requirement to a pre-process to 0 and temporarily stopping input, or making requirements to all processes to 0 and temporarily stopping input.

(4) According to the fourth aspect of the present invention, the amount of requirements can be steadily generated in a delivery plan or a leveling plan or the amount of requirements can be always generated by adding a dummy process. Accordingly, the amount of requirements can be dynamically controlled.

(5) According to the fifth aspect of the present invention, parameters can be optimized both on line and off line. In the production planning device 10, the behavior of a target process can be determined based on the amount of requirements from a post-process, the predetermined amount of products in progress and the achieved amount of products in progress. In the off-line system control device 20, even the generation of bottleneck can be flexibly coped with by optimizing parameters and determining the behavior of a target process, based on the amount of requirements from a post-process, the predetermined amount of products in progress and the achieved amount of products in progress. Accordingly, an efficient production plan can be made.

(6) According to the present invention, a push/pull method can also be always maintained in the best condition by analyzing the state of the amount of products in progress in each process and a production plan and setting the predetermined amount of products in progress in real time. By storing the predetermined amount of products in progress in memory, the fluctuation of the predetermined amount of products in progress can also be coped with in real time, and the deviation of the push/pull switching operation point can also be promptly corrected.

(7) According to the present invention, appropriate flow can also be realized by analyzing the state of the amount of products in progress in each process and its change rate and automatically modifying control parameters in memory dynamically.

(8) According to the present invention, the amount of products in progress in each process can also be flexibly controlled, based on the generation state of bottleneck.

The present invention comprises an on-line push/pull type production planning device and an off-line system control device. The production planning device calculates the starting lot of a target process, based on the amount of requirements from a post-process, a predetermined amount of products in progress and the achieved amount of products in progress. If the achieved amount of products in progress satisfies neither the amount of requirements nor the predetermined amount of products in progress, the shortage is made a new requirement to a pre-process. As described above, the amount of requirements is determined by the accumulation of requirements from post-processes, and even when there is bottleneck due to a facilities failure or the like in an intermediate process, the necessary amount of requirements is always transmitted to a pre-process.

If the achieved amount of products in progress reaches the marginal amount of products in progress due to a sudden facilities failure or the like, the generation of abnormal stock due to a temporary blockade is suppressed by clearing out the amount of requirements to a pre-process. If, for example, bottleneck occurs in facility, usually requirements from a post-process cannot be satisfied, the amount of requirements increases, and as a result, the actual amount of products in progress and the amount of requirements both increase. Therefore, the starting lot of a target process is manufactured based on the self-process optimization theory of the prior push type production method or the like.

When the amount of requirements from a post-process decreases as the bottleneck is solved, the amount of requirements to a pre-process also decreases. Furthermore, since in the target process, the valid amount of products in progress drops below the actual amount of products in progress, the amount of production approaches the amount of requirements from a post-process. Thus, in a normal state, the production method enters a pull type. As described above, a production method can be automatically switched from push to pull or vice versa, according to the state of products in progress.

The on-line system control device updates the predetermined amount of products in progress, the marginal amount of products in progress and starting parameters, and always maintains appropriate setting values. By this function, the production planning device can always maintain appropriate parameters at a planning timing and issue appropriate production instructions.

The preferred embodiments of the present invention are described in detail below with reference to the drawings.

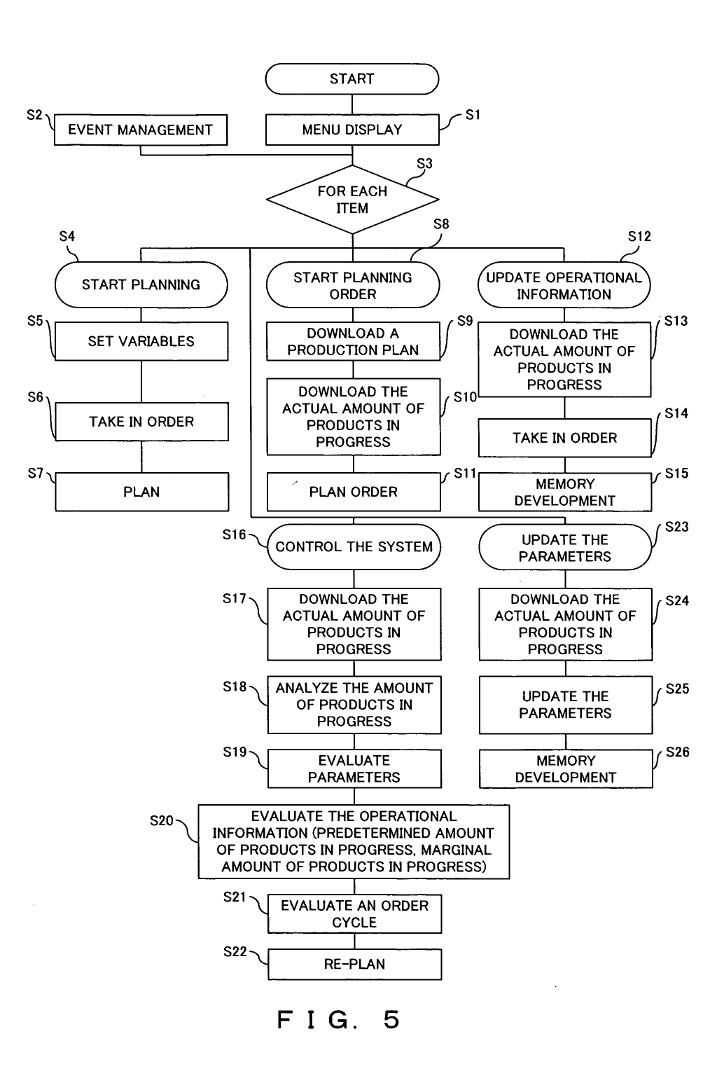

FIG. 5 is a flowchart showing the operation of the present invention. As its system configuration, one shown in FIG. 4 is used. The system displays a menu (S1). Alternatively, the system manages events (S2). Items are classified based on the menu display or the event management (S3). The classified items are distributed to planning start (S4), order planning start (S8), operational information update (S12), system control (S16) and parameter update (S23).

(a) Planning

In planning, firstly, the push/pull type production planning device 10 starts planning (S4). Then, variables are set in the control information storage unit 32 (S5). The lot/order information information storage unit 31 takes in order (S6). The production planning device 10 makes a plan, based on the taken order (S7).

(b) Order Planning

In order planning, the order planning unit 23 starts order planning (S8). The order planning unit 23 downloads a production plan from the lot/order information storage unit 31 (S9) and then downloads the actual amount of products in progress (S10). Then, the order planning unit 23 makes an order plan, based on the downloaded information (S11).

(c) Operational Information Update

In operational information update, firstly, the lot/order information storage unit 31 is started to operate. Then, the actual amount of products in progress is downloaded from the lot/order information storage unit 31 (S13), and order is taken in (S14). Then, they are stored in the lot/order information storage unit 31 (S15).

(d) System Control

In system control, the parameter setting unit 22 is started to operate (S16). Then, the actual amount of products in progress is downloaded from the lot/order information storage unit 31 (S17). The parameter setting unit 22 analyzes the actual amount of products in progress (S18), and evaluates parameters (S19). Then, operational information (predetermined amount of products in progress, marginal amount of products in progress) is evaluated (S20), order cycle is evaluated S21) and a new plan is made (S22).

(e) Parameter Update

In parameter update, firstly, the parameter setting unit 22 is started to operate (S16). Then, the actual amount of products in progress is downloaded from the lot/order information storage unit 31 (S24). Then, parameters are updated (S25). They are stored in the control information storage unit 32 (S26).

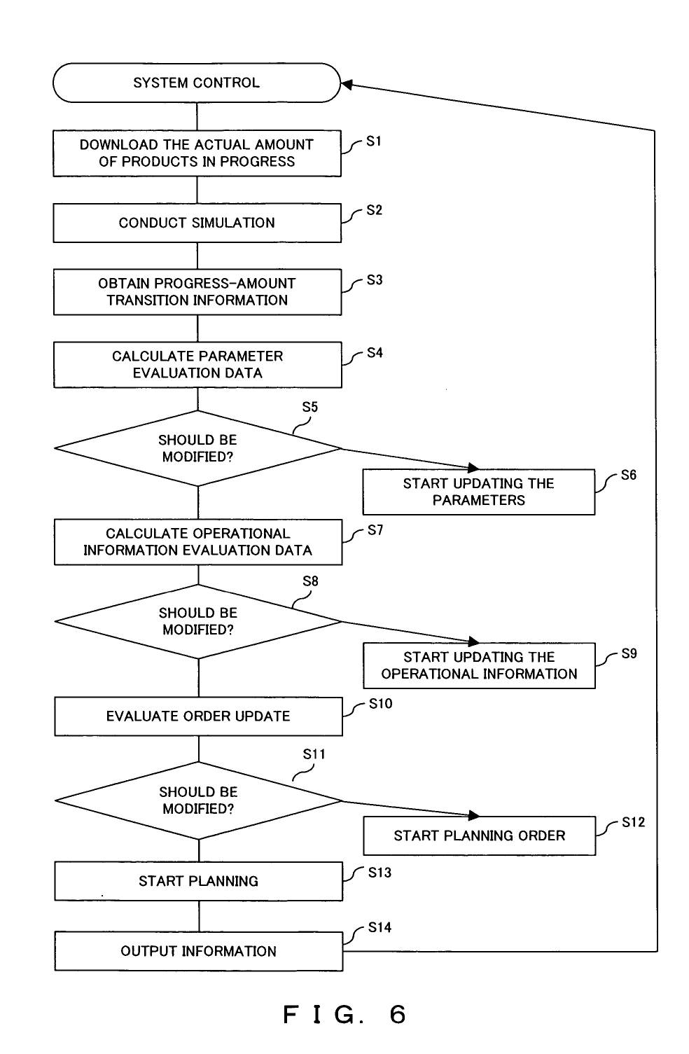

FIG. 6 is a flowchart showing the operation of the system control device 20. Firstly, the actual amount of products in progress is downloaded (S1). Then, process flow is simulated (S2). Progress-amount transition information is obtained by this simulation (S3). Then, parameter evaluation data is calculated (S4). Then, it is checked whether parameters should be modified (S5). If the parameters should be modified, parameter update is started (S6). If there is no need to modify the parameters, operational information evaluation data is calculated (S7).

Then, it is checked whether the operational information evaluation data should be modified (S8). If the operational information evaluation data should be modified, operational information update is started (S9). If there is no need to modify the operational information evaluation data, order update is evaluated (S10). Then, it is checked whether order should be modified (S11). If the order should be modified, order planning is started (S12). If there is no need to modify the order, planning is started (S13), and information is outputted (S14).

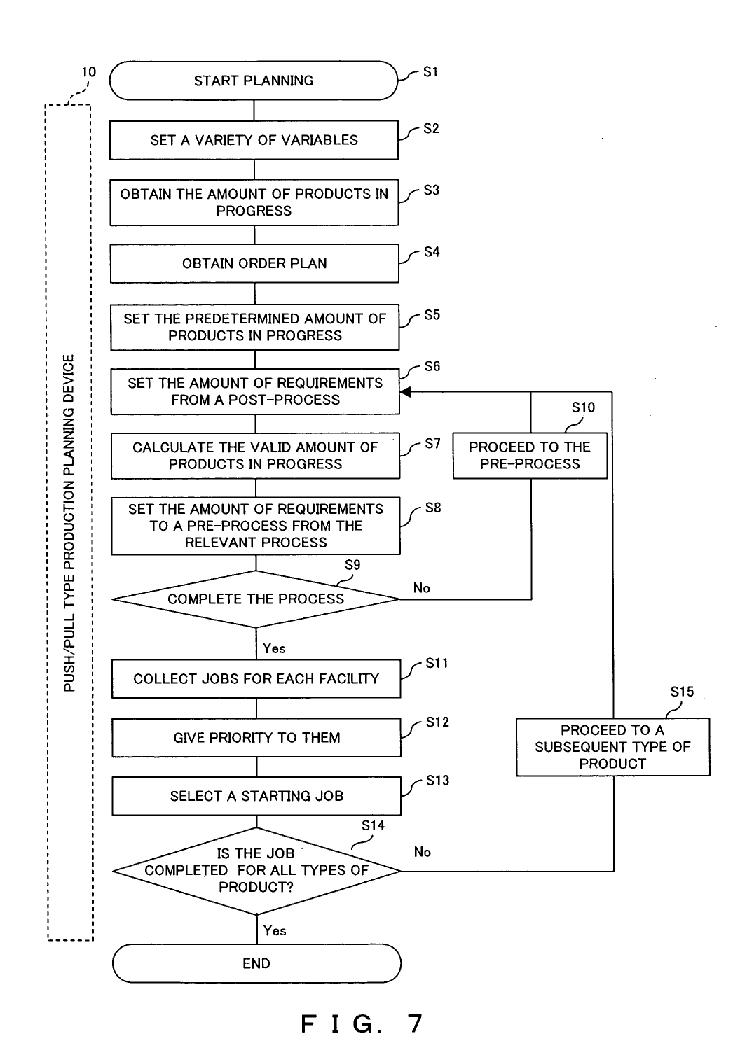

FIG. 7 is a flowchart showing the operation of the planning unit. This process is controlled by the push/pull type production planning device 20. Firstly, when the push/pull type production planning device 20 starts production planning (S1), it sets a variety of variables in the control information storage unit 32 (S2). Then, progress-amount information is obtained from the lot/order information storage unit 31 (S3), and then an order plan is obtained (S4). Then, the predetermined amount of products in progress is set in the control information storage unit 32 (S5).

Then, the required progress-amount setting unit 11 sets the amount of requirements from a post-process (S6). Then, the valid progress-amount calculation unit 12 calculates the valid amount of products in progress (S7). Then, the required progress-amount setting unit 11 sets the amount of requirements to a pre-process from the relevant process (S8). Then, it is checked whether the process is completed (S9). If the process is not completed, the flow proceeds to a pre-process (S10), and returns to step S6.

If the process is completed, the starting job selection unit 13 collects the jobs for each facility (S11), gives priority (S12) and selects a starting job (S13). Then, it is checked whether all types of products are completed (S14). If the job is not completed for all types of products, the flow proceeds to a subsequent type of product (S15), and the operation is started from step 6. If the job is completed for all types of products, the process is terminated.

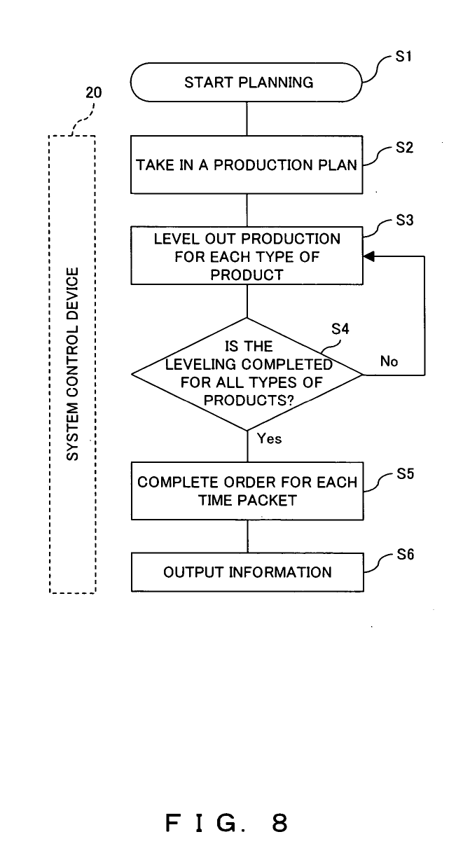

FIG. 8 is a flowchart showing the operation of the order planning unit. This process is performed by the system control device 20. Firstly, when planning is started (S1), a production plan is taken in from the lot/order information storage unit 31 (S2). Then, the order planning unit 23 levels out products for each type of product (S3). Then, it is checked whether the leveling is completed all types of products (S4). If the leveling is not completed all types of products, the flow returns to step S3. If the leveling is completed all types of products, the order planning unit 23 collects order for each time packet (S5), and outputs the information to the lot/order information storage unit 31 (S6).

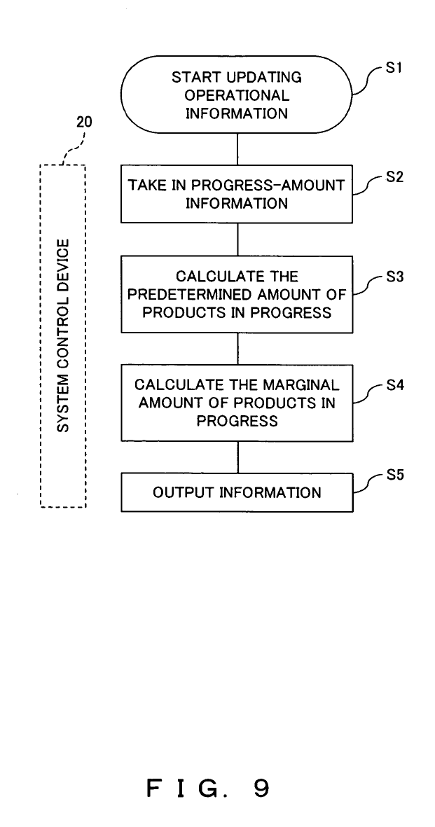

FIG. 9 is a flowchart showing the operational information update operation. This operation is mainly performed by the system control device 20. Firstly, when operational information update is started (S1), progress-amount information is taken in from the lot/order information storage unit 31 (S2). Then, the progress-amount setting unit 21 calculates the predetermined amount of products in progress (S3), and further calculates the marginal amount of products in progress (S4). Then, these segments of information are stored in the control information storage unit 32 from the progress-amount setting unit 21 (S5).

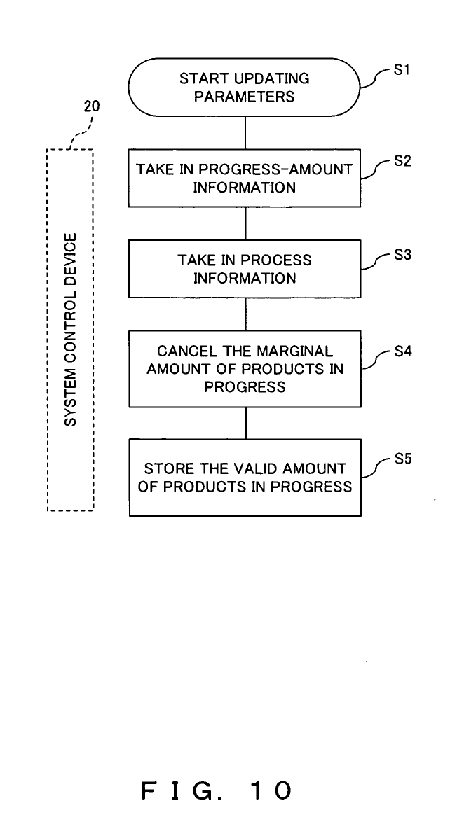

FIG. 10 is a flowchart showing parameter update operation. This operation is mainly performed by the system control device 20. Firstly, when parameter update operation is started (S1), the progress-amount information is taken in from the lot/order information storage unit 31 (S2). Then, the parameter setting unit 22 takes in process information (S3), and cancels the marginal amount of products in progress (S4). Then, the valid amount of products in progress is stored (S5).

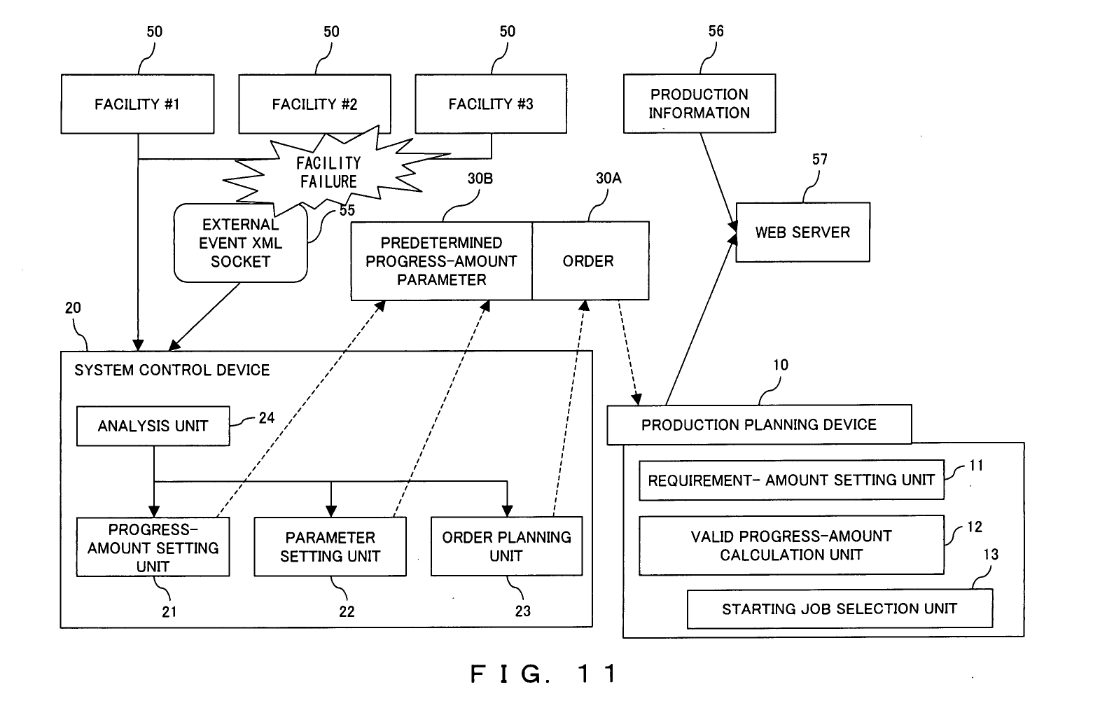

FIG. 11 is a block diagram showing the configuration of one preferred embodiment of the present invention. The same reference numerals are attached to the same components as in FIG. 4. In FIG. 11, reference numerals 10 and 20 represent a production planning device and a system control device, respectively. Reference numerals 30A and 30B represent memory 1 and 2, respectively. Reference numeral 50 represents facilities for process, and #1 through #3 indicates three segments of facilities. However, the number of facilities is not limited to three, and arbitrary segments of facilities can be used depending on a process. In the production planning device 10, reference numerals 11, 12 and 13 represent a required progress-amount setting unit, a valid progress-amount calculation unit and a starting job selection unit, respectively.

In the system control device 20, reference numerals 21, 22, 23 and 24 represent a progress-amount setting unit, a parameter setting unit, an order planning unit and an analysis unit connected to the progress-amount setting unit, the parameter setting unit and the order planning unit, for conducting analysis on production management. In memory 30, memory 30A stores order information from the order planning unit, and memory 30B stores the predetermined amount of products in progress from the progress-amount setting unit and parameters from the parameter setting unit 22. Reference numerals 55, 56 and 57 represent an external event XML (?) socket connected to the system control device 20, a board for indicating production information from a process, a WEB server for storing and displaying the production information and information from the production planning device 10, respectively.

The system shown in FIG. 11 is one for a semiconductor plant. In this system, the system control device 20 analyzes the amount of products in progress asynchronously every day, and checks whether operational information and control parameter should be modified. If the operational information and control parameter should be modified, the operational information or control parameter is updated on line. The operational information is transferred to a storage unit, and the control parameter is transferred to a storage unit which is a buffer for reflecting the control parameter in memory.

The order, for example, of a specific update event is executed, for example, at intervals of twelve hours or when the system control device receives a message from the outside. Then, the order is erased, the load is leveled out and the information of the order storage unit is updated. Furthermore, in the production planning device of the present invention, re-scheduling is conducted regularly, for example, at intervals of ten minutes or when the system control device receives a message from the outside, and the system is operated on line. In the re-scheduling timing, a variety of data is reflected in memory.

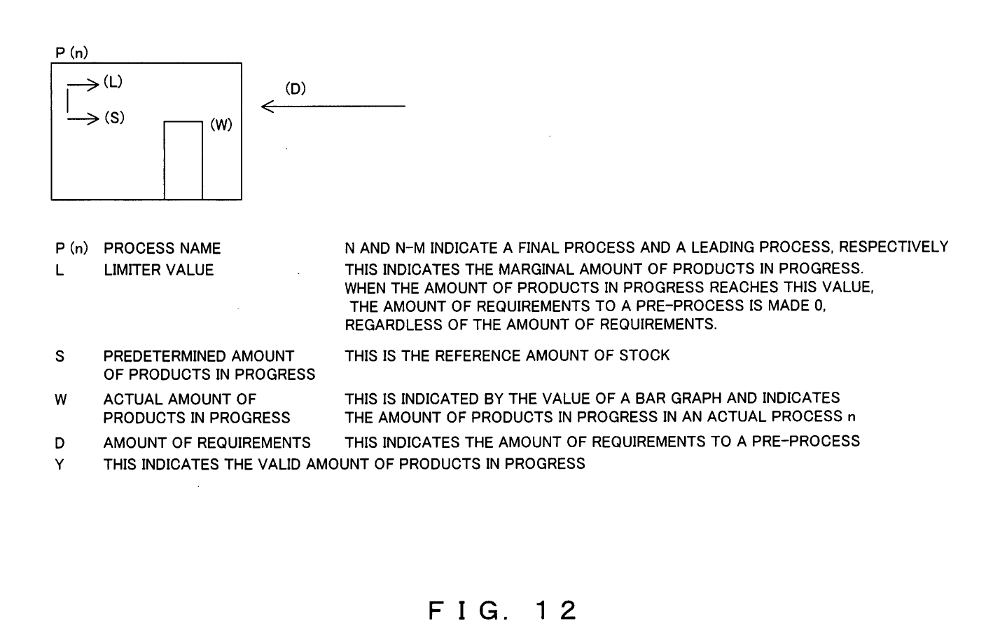

FIG. 12 explains parameters in each process. In FIG. 12, P(n) is a process name, and P(N) and P(N−M) indicate a final process and a leading process, respectively. L is a limiter value, and indicates the marginal amount of products in progress. When the amount of products in progress of a process reaches this value, the amount of requirements to a pre-process is made 0 regardless of the amount of requirements. S, D and Y indicate the actual amount of products in progress, the amount of requirements from a post-process to a pre-process and the valid amount of products in progress, respectively.

FIG. 12 shows a case where a process that has steadily operated so far falls into bottleneck due to an environmental change, such as production fluctuations, the fluctuations of product mixture or the like. In this case, actual products in progress accumulate before a bottlenecked process. Then, the system control device 20 controls the entire amount of products in progress so as to solve this accumulation and modifies control parameters (above-mentioned S, W, D, Y, etc.) (see FIG. 11).

As a result, the bottlenecked process has the sufficient amount of products in progress and it is difficult to the bottlenecked process to meet the amount of requirements from a post-process. Therefore, in order to cope with the bottleneck, a method for reducing the amount of products in progress most efficiently is adopted. This is usually based on a push type concept, and it means to neglect the state of a post-process when giving starting priority to a lot.

In the present invention, if the amount of requirements from a post-process is large, the entire actual amount of products in progress of the relevant process becomes the valid amount of products in progress. Therefore, push type logic is applied to all lots. If the process previously bottlenecked due to a facility failure or the like is already completely restored, and the amount of products in progress of the relevant process is being reduced, the predetermined amount of products in progress is reduced by the control system.

If the amount of requirements from a post-process is small, and the predetermined amount of products in progress S is small, the amount of requirements D can be satisfied by the actual amount of products in progress W of the relevant process. Therefore, the amount of requirements is satisfied and requirements D are not issued to a pre-process. In such a case, products can be manufactured from time to time according to the amount of requirements from a post-process, and requirements for the amount is issued to the pre-process. This is based on a pull type concept.

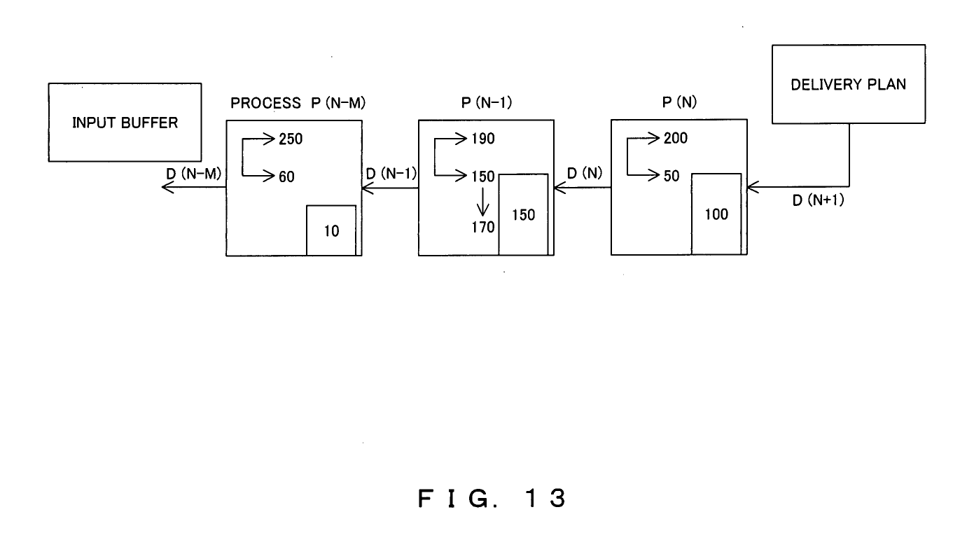

FIG. 13 explains an example of the first process of the present invention. FIG. 13 shows processes P(N−M) through P(N). In this example, instructions are issued based on a delivery plan, and the amount of products in progress in each process is controlled based on the delivery plan. FIG. 13 shows a case where a process that has steadily operated so far falls into bottleneck due to an environmental change, such as production fluctuations, the fluctuations of product mixture or the like. In this case, actual products in progress accumulate before a bottlenecked process. Then, the system control device 20 controls the entire amount of products in progress so as to solve this accumulation and modifies control parameters.

As a result, the bottlenecked process has the sufficient amount of products in progress and it is difficult to the bottlenecked process to meet the amount of requirements from a post-process. Therefore, in order to cope with the bottleneck, a method for reducing the amount of products in progress most efficiently is adopted. This is usually based on a push type concept, and it means to neglect the state of a post-process when giving starting priority to a lot.

In the present invention, if the amount of requirements from a post-process is large, the entire actual amount of products in progress of the relevant process becomes the valid amount of products in progress. Therefore, push type logic is applied to all lots. If the process previously bottlenecked due to a facility failure or the like is already completely restored, and the amount of products in progress of the relevant process is being reduced, the predetermined amount of products in progress is reduced by the control system.

If the amount of requirements from a post-process is small, and the predetermined amount of products in progress S is small, the amount of requirements D can be satisfied by the actual amount of products in progress W of the relevant process. Therefore, the amount of requirements is satisfied and requirements is not issued to a pre-process. In such a case, products can be manufactured from time to time according to the amount of requirements from a post-process, and requirements for the amount is issued to the pre-process. This is based on a pull type concept.

(a) In Case No Instruction Issued by a Delivery Plan (D(N+1)=0)

Firstly, as to process P(N), D(N+1)=0. Since the amount of products in progress S and the actual amount of products in progress W are 50 and 100, respectively, the following expression holds true.
D(N+1)+S(N)=0+50<W(N)(=100)
Since the predetermined amount of products in progress S(N) is smaller than the actual amount of products in progress W(N), there in no requirement D (N) from process P(N) to pre-process P(N−1). Namely, the amount of requirements D(N) and the valid amount of products in progress Y(N) become as follows.
D(N)=0
Y(N)=MIN (W(N), D(N+1))=MIN (100,0)=0

Since in a subsequent process P(N−1), the predetermined amount of products in progress S (N−1) and the actual amount of products in progress W(N−1) are 150 and 150, respectively, the following expression holds true.
D(N)+S(N−!)=+150=W(N−1)(=150)
Since the predetermined amount of products in progress S(N) is equal to the actual amount of products in progress W(N), there is no requirement D(N−1) from process P(N−1) to pre-process P(N−M). Namely, the following expression holds true.
D(N−1)=0

Since D(N)=0, the valid amount of products in progress Y(N−1) becomes as follows.
Y(N−1)=MIN(W(N−1), D(N))=MIN(150,0)
Since in a subsequent process P(N−M), the predetermined amount of products in progress S (N−M) and the actual amount of products in progress W(N−M) are 60 and 10, respectively, the following expression holds true.
D(N−1)+S(N−M)=0+60>W(N−M).
Since the predetermined amount of products in progress S(N−M) is larger than the actual amount of products in progress W(N−M), the following equation holds true.
D(N−M)=S(N−M)−W(N−M)=50
Since D(N−1)=0, the valid amount of products in progress Y(N−M) becomes as follows.
Y(N−M)=MIN(W(N−M), D(N−1))=MIN(10,0)=0

As described above, 50 are inputted in the process shown in FIG. 13, process P(N−M) is not performed, process P(N−1) is not performed and process P(N) is not performed.

In this case, the actual amount of products in progress W(N) of process P(N) is as follows.
W(N)=100>S(N)(=50)
The actual amount of products in progress W(N−1) of process P(N−1) becomes as follows.
W(N−1)=150−S(N−1)
The actual amount of products in progress W(N−M) of process P(N−M) becomes as follows.
W(N−M)=10<S(N−M)
The following equation also holds true.
W(N−M)=10b+50=S(N−M)
(b) In Case 70 Products are Instructed by a Delivery Plan (D(N+1)=70)

In this case, since 70 is instructed to be inputted to process P(N) by a delivery plan, the following expression holds true.
D(N+1)+S(N)=70+50=120>W(N)(=100)

In this case, requirements for half-finished products are issued to a pre-process. The amount of requirements D(N) becomes as follows.
D(N)=D(N+1)+S(N)−W(N)=120−100=20
However, the actual amount of predetermined amount of products in progress Y(N) becomes as follows.
Y(N)=MIN(W(N)<D(N+1))=MIN(100, 70)=70

Since in a subsequent process P(N−1), D(N)=230, the following expression holds true.
D(NH)+S(N−1)=20+150>W(N)(=150)

Therefore, in this case, the amount of requirements D (N−1) to a pre-process becomes as follows.
D(N−1)=D(N)+S(N−1)=W(N−1)=20+150−150=20
However, the valid amount of products in progress Y(N−1) becomes as follows.
Y(N−1)=MIN(W(N−1), D(N))=MIN(150, 20)=20

Since in a subsequent process P(N−M), D(N−1)=20, the following expression holds true.
D(N−1)+S(N−M)=20 60=80>W(N−M)(=10)

In this case, the following expression holds true.
D(N−M)=D(N−1)+S(N−M)−W(N−M)=20+60=80>W(N−M)(=10)
Therefore, the amount of requirements D(N−M) to a pre-process becomes as follows.
D(N−M)=D(N−1)+S(N−M)−W(N−M)=20+60−10=70
In this case, the valid amount of products in progress Y(N−M) becomes as follows.
Y(N−M)=MIN(W(N−M)<D(N−1))=MIN(10, 20)=10
As described above, 70 are inputted to the process shown in FIG. 13, 10 are processed in process P(N−M), 20 are processed and sent in process P(N−1) and 70 are processed and shipped.

In this case, the actual amount of products I progress W(N) in process P(N) becomes as follows.
W(N)=W(N)−D(N+1)=100−70=30
Since the actual amount of products in progress W(N−1) of 20 is processed and sent in process P(N−1), the following equation holds true.
W(N−1)=W(N−1)−D(N)=150−20=130
Since in this case, 30 outputted from process P(N−1) is added to W(N), the accumulated actual amount of products in progress W(N) of process P(N) becomes as follows.
W(N)=30+20=50
This is equal to the predetermined amount of products in progress S (N).

Since in process P(N−M), 10 are processed as described above, the actual amount of products in progress W(N−M) in process P(N−M) becomes as follows.
W(N−M)=W(N−M)−D(N−1)=60−20=40
Since in this case, 20 outputted from process P(N−M) are added to W(N−M), the accumulated actual amount of products in progress W(N−1) in process P(N−M) becomes as follows.
W(N−1)=130+20=150
This is equal to the predetermined amount of products in progress S (N−1) in process P (N−1). The actual amount of products in progress W (N−M) of process P (N−M) becomes as follows.
W(N−M)=40+20=60
This is equal to the predetermined amount of products in progress S(N−M) in process P(N−M).

As described so far, according to the present invention, the actual amount of products in progress is made equal to the predetermined amount of products in progress even if situations fluctuate. In other words, according to the present invention, by optimally controlling the amount of products in progress in each production process, an efficient production planning method by which a production process in which bottleneck fluctuates can follow up the fluctuation of the bottleneck and flexibly manufactures products and a device for implementing the method can be provided.

(c) In Case P(N−1) is Predicted to be Bottlenecked, S(N−1) is Updated from 150 to 170 and D(N+1)=0

Since in process P(N), D(N+1)=0, S(N)=50 and W(N)=100, the following expression holds true.
D(N+1)+S(N)=0+50<W(N)(=100)
Therefore, in this case, the amount of requirements D(N) to a pre-process becomes as follows.
D(N)=S(N)+D(N+1)−W(N)=50+0−100<0
However, in this case, D(N)=0. The valid amount of products in progress Y(N) becomes as follows.
Y(N)=MIN(W(N), D(N+1))=MIN(100,0)=0

Then, since in process P(N−1), D(N)=0 and S(N−1) is updated from 150 to 170, he following expression holds true.
D(N)+S(N−1)=0+170=170>W(N−1)(=150)

Therefore, D(N−1) becomes as follows.
D(N−1)=S(N−1)+D(N)−W(N−1)=170+0−150=20

The valid amount of products in progress Y(N−1) becomes as follows.
Y(N−1)=MIN(W(N−1), D(N))=MIN(150,0)=0

Then, since in process P(N−M), D(N−1)=20, S(N−M)=60, the following expression holds true.
D(N−1)+S(N−M)=20+60=80>W(N−M)(=10)
Therefore, D(N−M) becomes as follows.

$$\begin{matrix}D ( N - M ) = S ( N - M ) * D ( N - 19 - W ( N - M ) \\ = 60 + 20 - 10 \\ = 70\end{matrix}$$

In this case, the valid amount of products in progress Y(N−M) becomes as follows.
Y(N−M)=MIN(W(N−M), D(N−1))=MIN(10, 209=10

As described above, 70 half-finished products are inputted in the process shown in FIG. 13, process P (N−M) processes 10, process P(N−1) is not performed and process P(N) does not process 70.

In this case, in process P(N), the following equation holds true.
W(N)=W(N)−D(N+1)=100−0=100

In process P(N−1), the following expressions hold true.

$$\begin{matrix}W ( N - 1 ) = W ( N - 1 ) - D ( N ) \\ = 170 - 0 \\ = 170\end{matrix}$$

W(N)=100+0>S(N)

In process P (N−M), the following expressions hold true.

$$\begin{matrix}W ( N - M ) = W ( N - M ) - D ( N ) \\ = 10 - 10 \\ = 0\end{matrix}$$

W(N−1)=150+10=160<S(N−1)(=170)
In the input process, the following expression holds true.
W(N−M)=0+70>S(N−M)

Since in this state, the actual amount of products in progress is not made equal to the predetermined amount of products in progress if dispatch is conducted by one time of calculation, another dispatch of update process is necessary. Therefore, the process enters the following loop.

In process P(N), the following expression holds true.
D(N+1)+S(N)=50+10<W(N)(=100)
Therefore, D(N) becomes as follows.
D(N)=S(N)+D(N+1)−W(N)=50+0−100<0
Then,
D(N)=0
In this case, the valid amount of products in progress Y(N) becomes as follows.
Y(N)=MIN(W(N), D(N+1))=MIN(100,0)=0

Since in subsequent process P(N−1), D(N)=0, the following expression holds true.
D(N)+S(N−1)=0+170>W(N−1)(=100)
Therefore, the amount of requirements D(N−1) to a pre-process of process P(N−1) becomes as follows.

$$\begin{matrix}D ( N - 1 ) = S ( N - ! + D ( N ) - W ( N - 1 ) \\ = 170 + 0 - 160 \\ = 10\end{matrix}$$

In t5his case, the valid amount of products in progress Y(n−1) becomes as follows.
Y( )N−1)=MIN(W(N−1), D(N))=MIN(150,0)=0

Since in subsequent process P(N−M), D(N−1)=10, the following expression holds true.
D(N−1)+S(N−M)=10+60>W(N−M)(=10)

Therefore, D(N−M) is expressed as follows.
D(N−M)=S(N−M)+D(N−1)−W(N−M)=60+10−70−0

In this case, the valid amount pf products in progress Y(N−M) becomes as follows.
Y(N−M)=MIN(W(N−M), D(N−1))=MIN(70,10)=10
As described above, process P (N−M) processes 10, process P(N−1) is not performed and process P(N) does not process 70.

The actual amount of products in progress W (N) in process P(N) becomes as follows.
W(N)=W(N)−D(N+1)=100−=100

The actual amount of products in progress W(N−1) in process P(N−1) becomes as follows.
W(N−1)=W(N−1)−D(N)=160−0=160
In this case, W(N) becomes as follows.
W(N)=100+0>S(N)(=60)

The actual amount of products in progress W(N−M) in process P(N−M) becomes as follows.
W(N−M)=W(N−M)−D(N)=70−10=60=S(N−M)
In this case, W(N−1) becomes as follows.
W(N−1)=160+10=170=S(N−1)(=170)
W(N−M) on the input buffer side becomes as follows.
W(N−M)=60−S(N−M)

As described above, according to the present invention, even if situations changes, the actual amount of products in progress is made equal to the predetermined amount of products in progress.

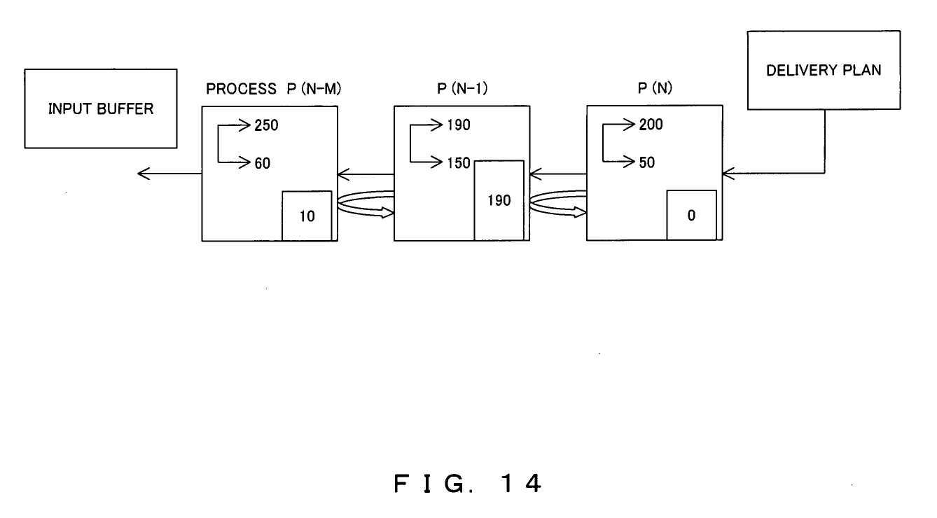

FIG. 14 shows an example of the second process of the present invention. This example shows a case where there is no room to re-set the predetermined amount of products in progress and the abnormal amount of products in progress is instantaneously generated. In such a case, if the actual amount of products in progress reaches the marginal amount of products in progress (limiter) set in a process, requirements to a pre-process are cancelled although requirements from a post-process increases greatly.

By doing so, the operation of a pre-process can be stopped and the behavior of the pre-process can be assimilated to suddenly generated bottleneck. Thus, the facility of the pre-process can exclusively engaged in a job for another facility, the risk of a just-in-time production method that the entire line is stopped by the failure of one segment of facility can be avoided, shelf stock can be reduced and the operation loss of the facility of a post-process can be minimized. The operation of each process shown in FIG. 14 is described below.

(a) In Case the Amount of Products in Progress of 190 in Process P(N−1) is Generated when 0 is Instructed by a Delivery Plan and the Actual Amount of Products in Progress Reaches the Marginal Amount of Products in Progress

Firstly, it is assumed that the amount of requirements D(N+1) in process P(N) is 0 (D(N+1)=0). In this case, the following expression holds true.
D(N+1)+S(N)=0+50>W(N)(=0)
Therefore, the amount of requirements D(N) to a pre-process can be expressed as follows.
D(N)=S(N)+D(N+1)−W(N)=50+0−0=50

In this case, the valid amount of products in progress Y(N) becomes as follows.
Y(N)=MIN(W(N), D(N+1))=MIN(0,0)=0
However, since in process P(N−1), D(N)=50, the following expression holds true.
D(N)+S(N−1)=50+150=200>W(N−1)(=190)
Therefore, D(N−1) becomes as follows.
D(N−1)=S(N−1)+PD(N)−W(N−1)=150+50−190=10

However, since the limiter value L (N−1)190 is W(N−1) (L(N−1) 190=W(N−1)), in this case, the following equation holds true.
D(N−1)=0
However, the valid amount of products in progress Y(N−1) can be expressed as follows.
Y(N−1)=MIN(W(N−1), D(N))=MIN(190, 50)=50
However, since process P(N−1) is stopped, no process cannot be performed.

Since in subsequent process P(N−M), D(N−1)=0, the following expression holds true.
D(N−1)+S(N−M)=0 60>W(N−M)(=10)

Therefore, D(N−M) outputted in process P(N−M) becomes as follows.

$$\begin{matrix}D ( N - M ) = S ( N - M ) + D ( N - 1 ) - W ( N - M ) \\ = 60 + - 10 \\ = 50\end{matrix}$$

In this case, the valid amount of products in progress Y(N−M) becomes as follows.
Y(N−M)=MIN(W(N−M), D(N−1))=MIN(10,0)=0
As a result, the input buffer input 50 in process P (N−M), process P(N−1) is not performed, and process P(N−1) cannot be performed. Process P(N) cannot also be performed.

In this case, W(N) in process P(N) becomes as follows,
W(N)=0−0=0
In process P(N−1), W(N−1) becomes as follows.
W(N−1)=190−0=190
In this case, the following expression holds true.
W(N)=0+<S(N)(=50)
In subsequent process P (N−M), the following expressions hold true.
W(N−M)=10−0=10
W(N−1)=190+0=190>S(N−1)(=150)
In the input process, the following equation holds true.
W(N−M)=10+50=60(=S(N−M))

As described, if abnormal accumulation occurs, the process is stopped after only a necessary amount is manufactured. Thus, wasteful production can be suppressed. As described above, according to the present invention, the flow of the entire production can be made smooth by providing the amount of products in progress with a limit and making requirements to a pre-process 0 when the amount of products in progress reaches the limit.

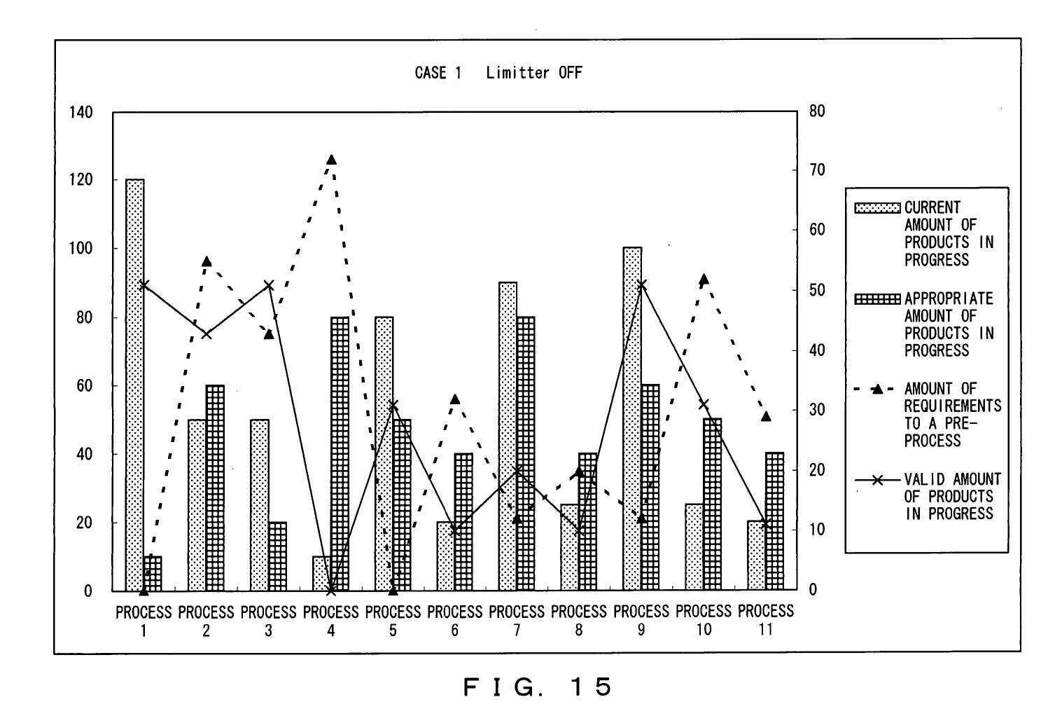

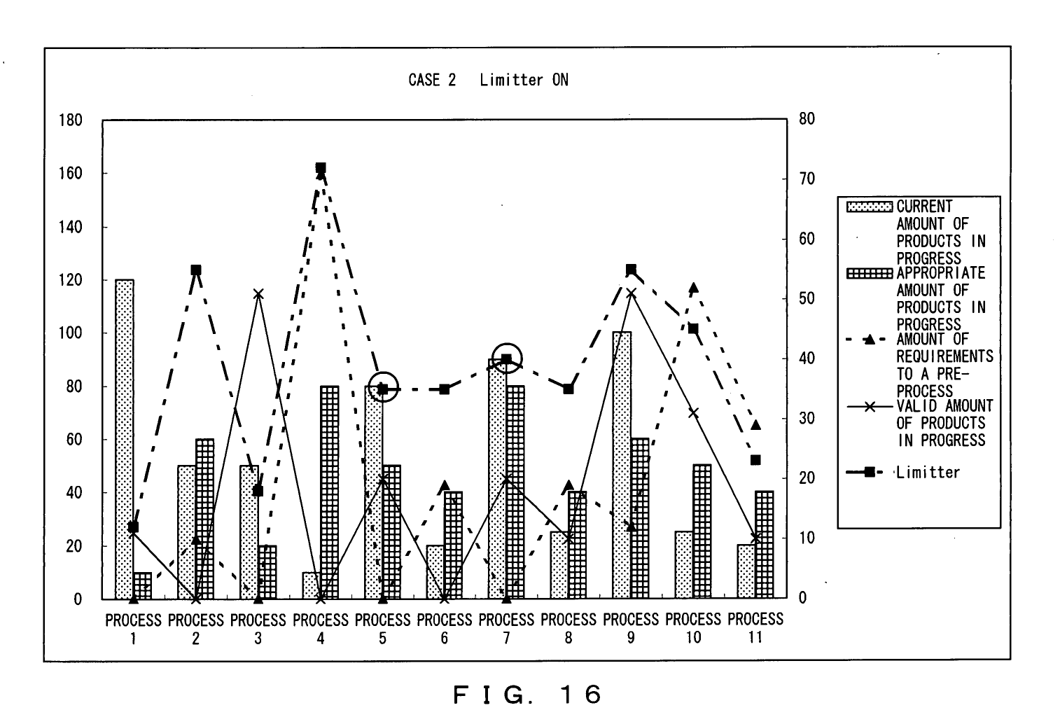

FIG. 15 shows the transition of each amount of products in progress at the time of limiter-off, and FIG. 16 shows that at the time of limiter-on. In each of FIGS. 15 and 16, the horizontal and vertical axes indicate the transition of a process and the amount of products in progress, respectively. FIG. 15 shows the current amount of products in progress, the appropriate amount of products in progress, the amount of requirements to a pre-process and the valid amount of products in progress. FIG. 16 shows a limiter in addition to the above-mentioned amount of products in progress.

According to the present invention, if the valid amount of products in progress collected for each facility is 0, a lot with top priority of the entire amount of products in progress of the relevant facility is started to process. Alternatively, manual work is stopped until the valid amount of products in progress exceeds 1. If the facility is bottlenecked, priority is given to an availability factor and the process is performed. If the bottleneck is solved by a stable operation, the amount of products in progress is suppressed. Furthermore, starting processing a lot with top priority of the entire amount of products in progress of the relevant facility and stopping a job until the valid amount of products in progress exceeds 1 can be dynamically switched by parameters on memory. Thus, an efficient production planning method and a device for implementing the method can be provided.

According to the present invention, a pull order generation function can also be provided in the final process. Thus, the amount of requirements in a delivery plan or a leveling plan can be generated. Alternatively, the amount of requirements can be steadily generated by adding a dummy process. Thus, the amount of requirements can be dynamically controlled.

According to the present invention, the predetermined amount of products in progress can also be set in real time by analyzing the state of the amount of products in progress in all the processes and a production plan. Thus, by setting the predetermined amount of products in progress in real time by analyzing the state of the amount of products in progress in all the processes and a production plan, the push/pull method can be always maintained in the best condition. By storing the predetermined amount of products in progress in memory, fluctuations in the predetermined amount of products in progress can be coped with, and even if there is a deviation in the push/pull switching operation point, the deviation can be promptly corrected.

According to the present invention, the control parameters in memory can also be dynamically modified by analyzing the state of the amount of products in progress in all the processes and a change rate. Thus, by analyzing the state of the amount of products in progress in all the processes and a change rate and automatically modifying control parameters in memory, appropriate production flow can be always realized.

According to the present invention, the predetermined progress-amount information, limiter information, the actual progress-amount information, starting principle information of all processes are provided in memory as schedulers. The system control device comprises a predetermined progress-amount setting unit and a control parameter setting unit. The push/pull type production planning device comprises a required progress-amount calculation unit, a valid progress-amount calculation unit and a starting job selection unit. Thus, the amount of products in progress in each process can be flexibly controlled according to the occurrence state of bottleneck.

Although in the above-mentioned preferred embodiments, the process of the present invention is applied to a semiconductor plant, the application of the present invention is not limited to these. Similarly, the present invention can be applied other manufacturing processes for conducting variable-type and variable-amount production.

1. A production planning method, comprising:
calculating an amount of requirements to a pre-process, based on a difference between a sum of an predetermined amount of products in progress set in each process and an amount of requirements from a post-process, and an actual amount of products in progress, and notifying the pre-process of the difference as an accumulated amount of requirements of the post-process (step 1);
calculating a valid amount of products in progress, based on an actual amount of products in progress and an amount of requirements in each process (step 2); and
dynamically switching and performing a pull type production process if the actual amount of products in progress>the amount of requirements, and a push type production process if the actual amount of products in progress<the amount of requirements, based on a relationship between the actual amount of products in progress and the amount of requirements in each process (step 3).

2. The production planning method according to claim 1, wherein
if the valid amount of products in progress for each facility is 0, a lot with top priority of the entire amount of products in progress of the relevant facility is started to process or manual work is stopped until the valid amount of products in progress exceeds 1;
if the facility is bottlenecked, the process is performed giving priority to an operation rate;
if a stable operation is restored and the bottleneck is solved, the amount of products in progress is suppressed; and
furthermore, starting processing a lot with top priority of all the amount of products in progress of the facility and stopping work until the valid amount of products in progress exceeds 1 is dynamically switched by parameters in memory.

3. The production planning method according to claim 1, wherein
the marginal amount of products in progress is provided against the actual amount of products in progress in addition to the predetermined amount of products in progress in each process; and
if the actual amount of products in progress exceeds the marginal amount of products in progress, the requirement to a pre-process is made 0, the requirements to all pre-processes are made 0, the requirement to a pre-process is made 0 and input is temporarily stopped, or the requirements to all pre-processes are made 0 and input is temporarily stopped.

4. The production planning method according to claim 1, wherein
a push operation is performed in the final process, or a pull order generation function is provided and utilized.

5. A production planning apparatus in a production line for conducting production in each process, comprising:
an on-line push/pull type production planning device;
an off-line system control device; and
a memory connected to the push/pull type production planning device and the system control device, for storing a variety of information,
said push/pull type production planning device determines the behavior of a target process based on the amount of requirements from a post-process, the predetermined amount of products in progress and the achieved amount of products in progress; and
said system control device optimizes parameters.

6. The production planning method according to claim 1, wherein
the predetermined amount of products in progress is set in real time by analyzing the state of the amount of products in progress in all processes and a production plan.

7. The production planning method according to claim 1, wherein
control parameters in the memory are automatically modified dynamically by analyzing the state of the amount of products in progress in all processes and its change rate.

8. The production planning apparatus according to claim 5, wherein
predetermined progress-amount information, limiter information, actual progress-amount information and starting principle information of all processes are provided in the memory as schedulers;
said system control device comprises
a predetermined progress-amount information setting unit; and
a control parameter setting unit,
said push/pull type production planning device comprises a required progress-amount calculation unit;
a valid progress-amount calculation unit; and
a starting job selection unit.

9. A program enabling a computer to perform a production planning method comprising:
calculating an amount of requirements to a pre-process, based on a difference between a sum of an predetermined amount of products in progress set in each process and an amount of requirements from a post-process, and an actual amount of products in progress, and notifying the pre-process of the difference as an accumulated amount of requirements of the post-process;
calculating a valid amount of products in progress, based on an actual amount of products in progress and an amount of requirements in each process; and
dynamically switching and performing a pull type production process if the actual amount of products in progress>the amount of requirements, and a push type production process if the actual amount of products in progress>the amount of requirements, based on a relationship between the actual amount of products in progress and the amount of requirements in each process.

10. The program enabling a computer to perform the production planning method according to claim 9, wherein
if the valid amount of products in progress for each facility is 0, a lot with top priority of the entire amount of products in progress of the relevant facility is started to process or manual work is stopped until the valid amount of products in progress exceeds 1;
if the facility is bottlenecked, the process is performed giving priority to an operation rate;
if a stable operation is restored and the bottleneck is solved, the amount of products in progress is suppressed; and
furthermore, starting processing a lot with top priority of all the amount of products in progress of the facility and stopping work until the valid amount of products in progress exceeds 1 is dynamically switched by parameters in memory.

11. The program enabling a computer to perform the production planning method according to claim 9, wherein
the marginal amount of products in progress is provided against the actual amount of products in progress in addition to the predetermined amount of products in progress in each process; and
if the actual amount of products in progress exceeds the marginal amount of products in progress, the requirement to a pre-process is made 0, the requirements to all pre-processes are made 0, the requirement to a pre-process is made 0 and input; is temporarily stopped, or the requirements to all pre-processes are made 0 and input is temporarily stopped.

12. The program enabling a computer to perform the production planning method according to claim 9, wherein
a push operation is performed in the final process, or a pull order generation function is provided and utilized.

13. The program enabling a computer to perform the production planning method according to claim 9, wherein
the predetermined amount of products in progress is set in real time by analyzing the state of the amount of products in progress in all processes and a production plan.

14. The program enabling a computer to perform the production planning method according to claim 9, wherein
control parameters in the memory are automatically modified dynamically by analyzing the state of the amount of products in progress in all processes and its change rate.
